(19) United States
(12) Patent Application Publication
(10) Pub. No.: US 2016/0224138 A1
(43) Pub. Date: Aug. 4, 2016

(54) Semi-Adhesive, Conductive Finger Stylus

(71) Applicant: Gordon K. Adkins, Apalachicola, FL (US)

(72) Inventor: Gordon K. Adkins, Apalachicola, FL (US)

(21) Appl. No.: 14/613,347

(22) Filed: Feb. 3, 2015

(51) Int. Cl. G06F 3/0354; G06F 3/01; G06F 3/044

(52) U.S. Cl. CPC G06F 3/03545; G06F 3/044; G06F 3/014

(57) ABSTRACT

A cutout of electrically conductive foam which can be attached to a biological or prosthetic limb or other object. The cutout is intended to be used on the capacitive touch screen of an electronic device. In order to operate on a capacitive touch screen, the foam cutout is typically attached to an object having a capacitance. If the cutout is attached to a user's biological hand or finger, then the capacitance from the user's skin is conducted through the cutout. The invention includes a method for integrating a capacitive material into a prosthetic limb in order to use a touch screen. While in use, only the cutout is in contact with the screen. The foam cutout is furnished with a reusable adhesive applied to one end. This adhesive allows the user to temporarily attach the cutout to biological hand members, hands, feet, foot members, prosthetic limbs, or other objects.

### CROSS-REFERENCES TO RELATED APPLICATIONS

This non-provisional patent application claims the benefit of two earlier-filed provisional patent applications. The first provisional application was assigned Ser. No. 61/935,007. It was filed on Feb. 3, 2014. The second referenced provisional application was assigned Ser. No. 62/009,386. It was filed on Jun. 9, 2014. The listed inventor is the same in all three applications.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of a stylus intended to be used with a touch screen. More specifically, the current invention comprises an electrically conductive foam cutout which acts as a stylus while attached to an electrically capacitive body.

2. Description of Related Art

Today, nearly every cellular phone is furnished with a touch screen. In addition to phones, other devices are navigated using a touch screen, including computers, tablets, and electronic readers. Despite the increased use and popularity of touch screens, there are some drawbacks associated with them. For example, a resistive-type touch screen can easily open applications or call contacts while in the user's pocket if the screen is not locked. In addition, a capacitance-type touch screen cannot be used with non-conductive gloves, thereby requiring the user to remove his or her gloves in order to access the phone.

One drawback of using a touch screen is a lack of precision while using the fingers to navigate the screen. This lack of precision has led to the introduction of a stylus pen. A stylus pen, often referred to as just a stylus, allows the user to easily and more accurately navigate a touch screen device. Also, a stylus allows the user to easily take notes as if he or she were writing on paper.

Some stylus pens are designed to work with a certain device. In this case, the stylus usually is battery powered and there is a wireless connection from the stylus to the device it is being used to control. Other stylus pens act to replace a user's finger. This can be achieved by including an electrically conductive tip for capacitance screens or the mere presence of the pen for resistive screens. This allows the user to have a precise device in order to navigate a touch screen without much complication, like syncing the stylus and device or replacing batteries.

Although a pen stylus does assist the user with precision while navigating a touch screen, it does present drawbacks. First, the user must carry the stylus with them. This may lead to more hassle and the likelihood of misplacing the stylus is high. Second, a pen stylus still requires the user to grasp the stylus like a pen. A user with prosthetic arms or hands cannot do this. Finally, repeatedly using a pen stylus on a touch screen tends to scratch the screen.

Currently, nearly all electronic devices are produced using capacitance based touch screens. While resistive screens are slightly more durable, the advantages of capacitive touch screens are enormous. These advantages include a clearer and sharper picture, more accurate and responsive sensing, and dual touch capabilities. Thus, some inventors have explored more effective ways of navigating capacitive touch screens. An example of a capacitive stylus is found in U.S. Pat. No. 5,914,708 to LaGrange. The LaGrange device is pen-shaped with a capacitive core which allows the user to operate an electronic device with a capacitive touch screen.

Unfortunately, capacitance touch screens are not convenient (or oftentimes even operable) for individuals with prosthetic limbs. There are many individuals with prosthetic arms. The primary causes of amputation are trauma, disease, and congenital conditions. The type of prosthesis attached to a patient depends on the type of amputation, age and activity level of the patient, and lifestyle of the patient. The prosthetic limb can be functional, strictly aesthetic, or a combination of both.

Even with the advances made in prostheses, it is common for individuals with prosthetic limbs to struggle with tasks that are trivial for individuals with normal limbs. The ability to operate a touch screen is no exception. Unfortunately, individuals with prosthetic limbs generally cannot use capacitance touch screens. Because capacitance touch screens use the capacitance from the body of the user in order to sense where a user has touched the screen, an individual using a prosthetic limb cannot interact with these devices. For a typical user, the screen is able to detect a change in capacitance caused by the additional capacitance of the user's body. However, this additional capacitance is not transferable from the body to the user's prosthetic limb. The present invention and method solves these and other problems, as will be described more particularly in the following text.

### BRIEF SUMMARY OF THE INVENTION

The present invention comprises a cylindrical cutout of electrically conductive foam which can be attached to a biological or prosthetic limb or other object. The electrically conductive cutout is intended to be used on the capacitive touch screen of an electronic device. In order to operate on a capacitive touch screen, the foam cutout is typically attached to an object having a capacitance. If the cutout is attached to a user's biological hand or finger, then the capacitance from the user's skin is conducted through the cutout, thereby allowing the user to operate the touch screen. However, in the case of most prosthetic limbs the capacitance of a user's body does not conduct through the prosthetic limb.

Thus, the present invention includes a method for integrating a capacitive material into a prosthetic limb, thereby allowing the user to use a capacitance touch screen. Of course, this application is in addition to a user operating a capacitive touch screen with his or her natural limbs with the conductive cutout. While in use, only the cutout is in contact with the screen. Due to the conductivity of the foam, the invention can be used on touch screens that use capacitance to detect touch as well as resistive touch screens. In addition, the foam cutout is furnished with a reusable adhesive applied to one end. This adhesive allows the user to temporarily attach the cutout to biological hand members, hands, feet, foot members, prosthetic limbs, or other objects.

BRIEF DESCRIPTION OF THE SEVERAL VIEWS OF THE DRAWINGS

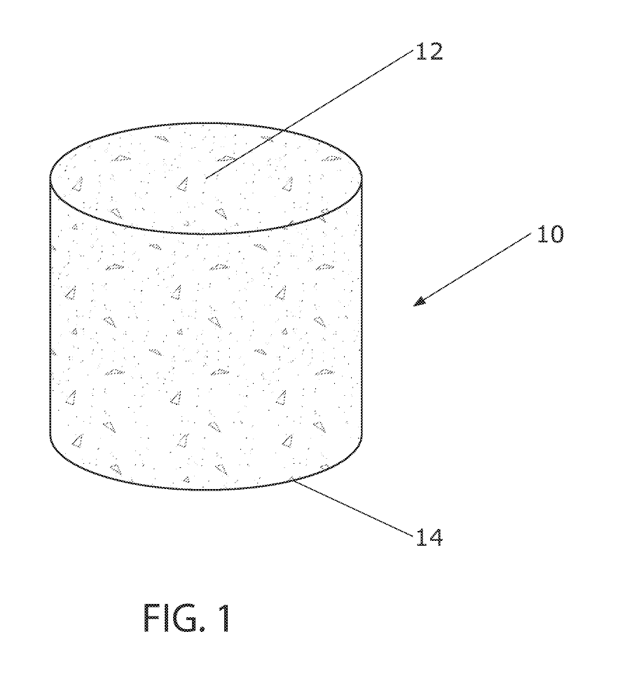

FIG. 1 is a perspective view, showing a preferred embodiment of the conductive foam cutout.

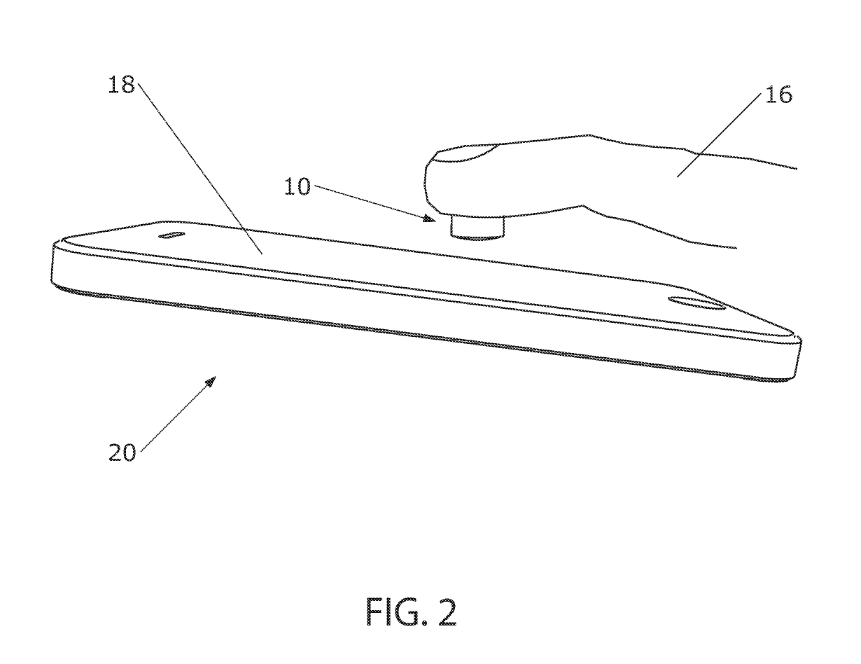

FIG. 2 is a perspective view, showing the conductive foam cutout attached to a user's biological finger.

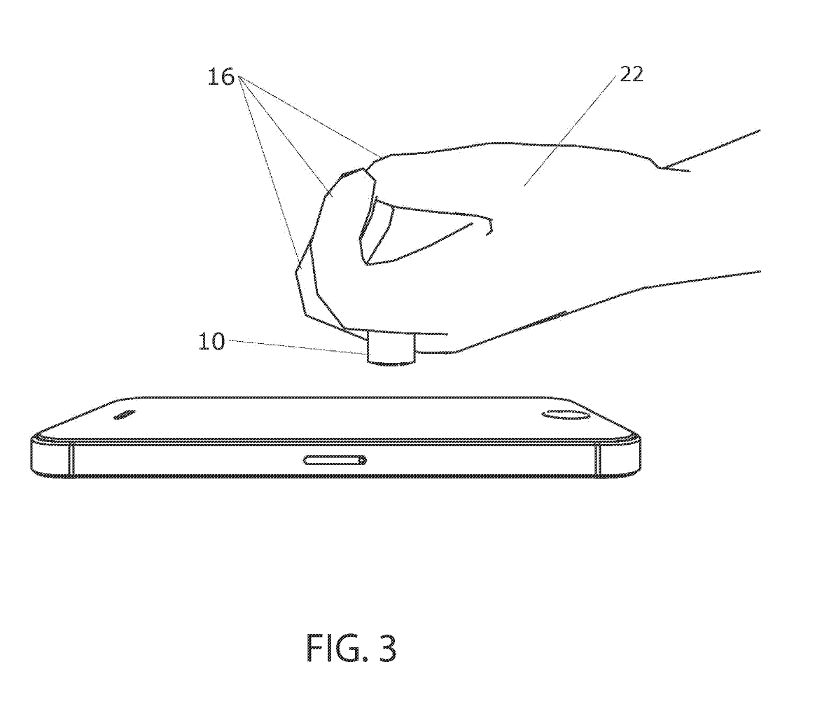

FIG. 3 is a perspective view, showing the present invention attached to the backside of a user's hand or finger.

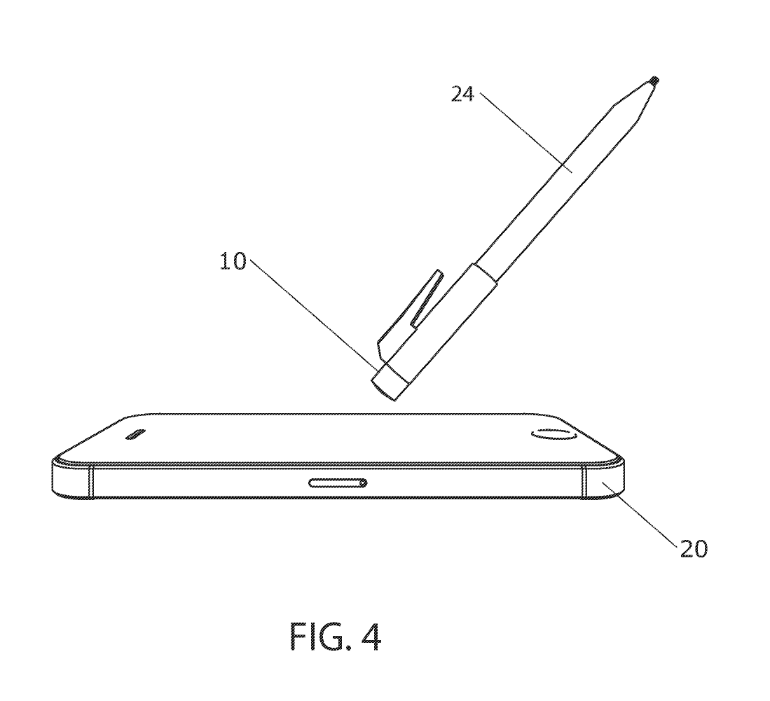

FIG. 4 is a perspective view, showing the present invention attached to the end of a writing utensil.

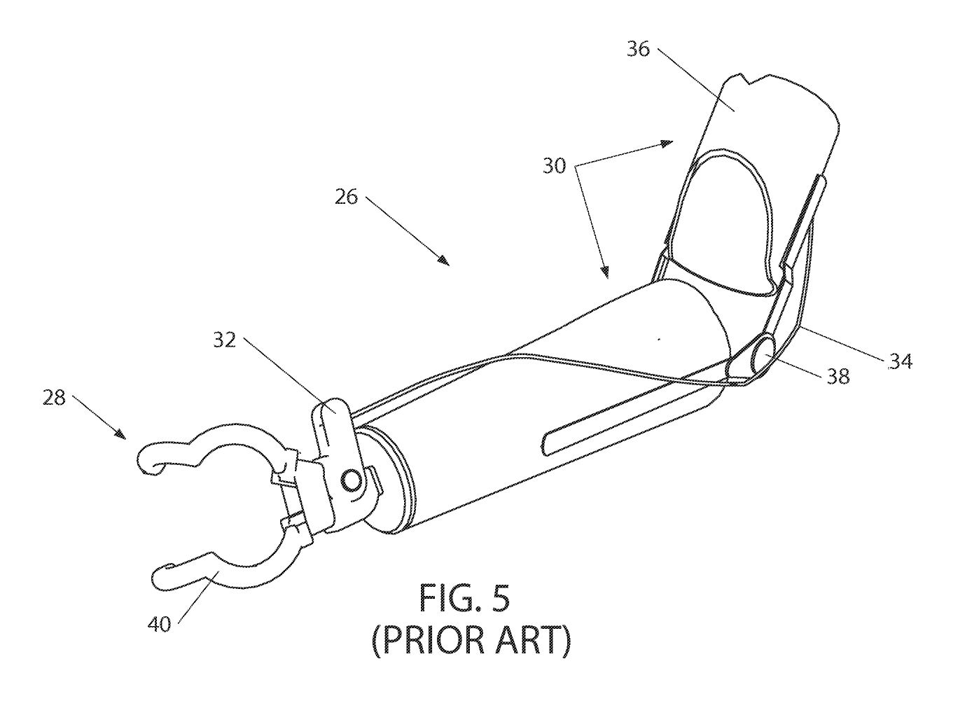

FIG. 5 is a perspective view, showing a prior art prosthetic arm.

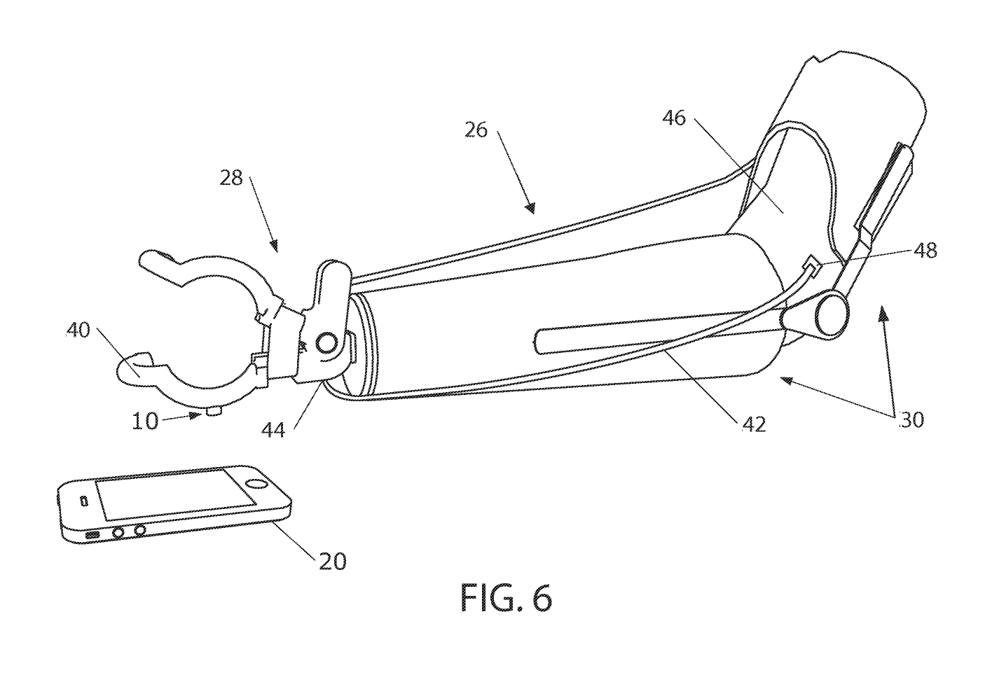

FIG. 6 is a perspective view, showing a prosthetic arm with a preferred embodiment of the present invention attached.

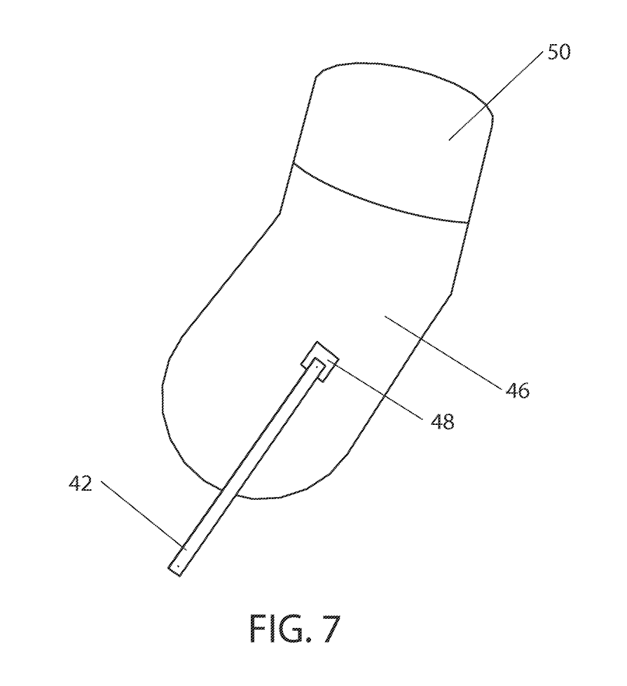

FIG. 7 is an elevation view, showing a wire attached to a prosthesis sleeve.

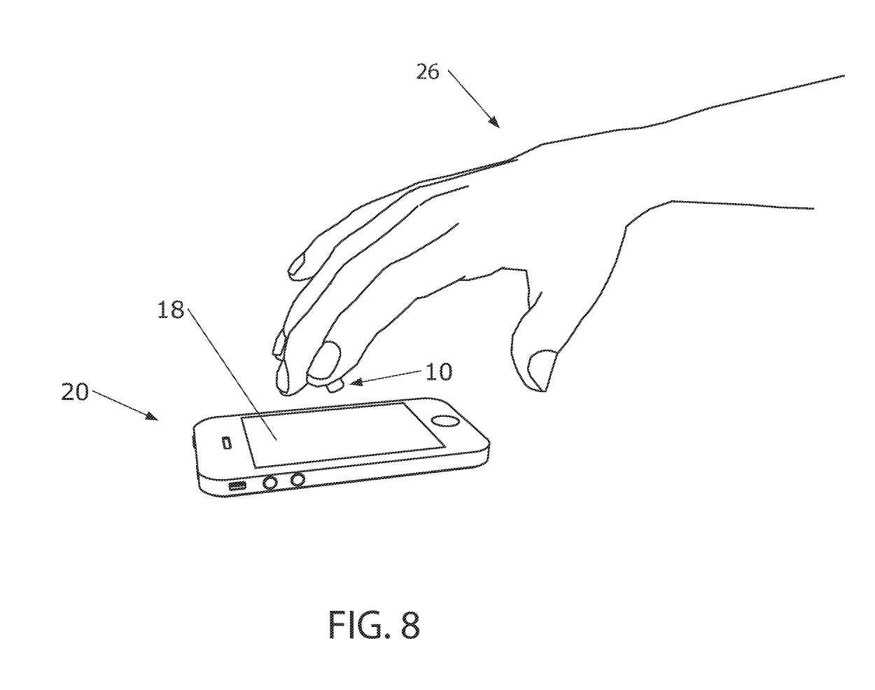

FIG. 8 is a perspective view, showing a prosthetic arm with the current invention attached.

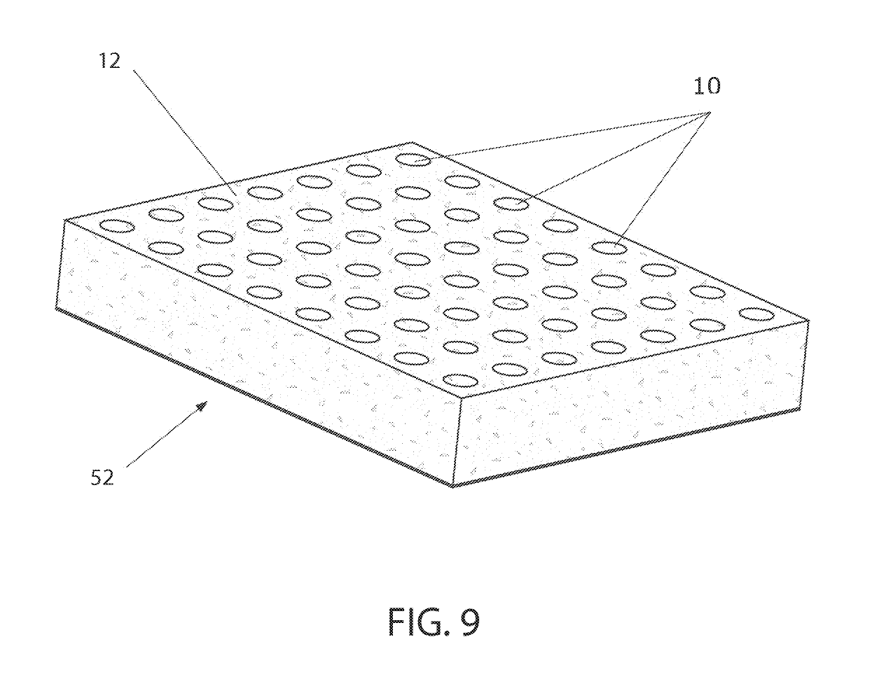

FIG. 9 is a perspective view, showing a preferred packaging and fabrication method of the present invention.

### REFERENCE NUMERALS IN THE DRAWINGS

10 foam cutout
12 screen contact end
14 adhesive end.
16 user's hand member
18 touch screen
20 electronic device
22 user's hand
24 writing utensil
26 prosthetic arm
28 grasping mechanism
30 pylon
32 lever
34 cable
36 upper section
38 joint
40 hook-shaped grasper
42 wire
44 connection point
46 sleeve
48 conductive material
50 user's arm
52 foam square

### DETAILED DESCRIPTION OF THE INVENTION

The present invention provides a conductive cutout and method to use the same with a biological or prosthetic limb on a capacitive touch screen. FIG. 1 shows the conductive foam cutout 10. In a preferred embodiment of the present invention, foam cutout 10 is cylindrical, having a top and a bottom. However, foam cutout 10 can come in multiple shapes such that the profile is rectangular, square, oval, triangular, or any shape that may improve the comfort and precision of cutout 10. The top of cutout 10 (in this view) contacts the touch screen in use. Screen contact end 12, or the top of cutout 10 preferably contains a fillet. This allows better contact with the touch screen if foam cutout 10 is not applied to the touch screen in a manner such that screen contact end 12 is parallel to the touch screen. For instance, if foam cutout is angled thirty degrees from the parallel face of the touch screen, a fillet increases the contact area due to the tangency at some point on the fillet.

The foam material preferably compresses under only a moderate force. That way, if the user misaligns the cutout with the touch screen the foam will deform and provide an expanded contact area as the user presses it toward the screen. This is a significant feature, since many capacitive screens require a “contact patch” having a diameter of around 4 mm or more.

The bottom of foam cutout 10 preferably includes an adhesive that may be used to attach foam cutout 10 to an intended object. This second end is therefore referred to as adhesive end 14. Preferably, the adhesive applied to adhesive end 14 is reusable, thereby allowing the user to apply cutout 10 to an object, remove cutout 10, then reply and use cutout 10. Of course, eventually the adhesive will grow weak, but the disposable and inexpensive nature of the cutout 10 helps to diminish these concerns. In a preferred embodiment of the present invention, adhesive end 14 is flat, maximizing the contact area possible between foam cutout 10 and the intended object to which it is attached. The adhesive used preferably does not impede a conductive connection between adhesive end 14 and the object to which the foam cutout is attached. The objects to which foam cutout 10 is intended to be attached are discussed in the subsequent text.

In a preferred embodiment of the current invention, foam cutout 10 is fabricated using a foam material, making it porous by nature. The material is preferably electrically conductive. This property allows foam cutout 10 to be used on multiple variations of touch screens. The reader will realize, however, that nearly all touch screens manufactured today are capacitive touch screens. The conductivity is discussed further in the subsequent text.

One of many possible applications of foam cutout 10 is to be applied to a user's hand or hand members. Foam cutout 10 is capable of attachment to any of the five members contained within a user's hand. FIG. 2 shows foam cutout 10 attached to one of those members (a finger). Adhesive end 14 is attached to user's hand member 16. With foam cutout 10 temporarily attached to user's hand member 16, the user is able to navigate touch screen 18 on electronic device 20. Attaching foam cutout 10 to one or more of user's hand members 16 allows for more precise operation of touch screen 18. The reader should note that while foam cutout 10 is shown attached to user's first member 16, cutout 110 can be attached to any of the five of user's members 16. For example many users employ the thumbs in order to text message or draft e-mails. Cutout 10 can easily be placed on each of the thumbs in order to type text.

The increased precision realized by using cutout 10 on a user's biological hand members is especially relevant in a few instances. First, users with larger hand members 16 often have trouble pressing the correct position on touch screen 18. This may lead to misspelling words while text messaging or incorrect moves or placement while playing a game. Second, having foam cutout 10 attached to multiple hand members 16 (on one or both hands) allows for easy navigation on larger electronic devices 20, such as a tablet. Some of the more complicated applications on electronic device 20 require more than one hand to be used by the operator. By attaching foam cutout 10 to multiple hand members 16 on one or both hands, the user has more flexibility, ease of operation, and precision. Finally, oil and dirt from hand members 16 often smudge touch screen 18. Preferably, foam cutout 10 prevents direct contact between hand member 16 and touch screen 18, thereby limiting dirt and oil on touch screen 18.

FIG. 3 shows foam cutout 10 attached to the backside of user's hand 22. It is quite common for one to eventually lose mobility in one's limbs. As a person ages, the ability to turn one's hands in a position in order to type (or perform similar tasks) often becomes limited. Typically, there comes a point when an older person loses many of the functions in the appendages that he or she once had. This can be caused by arthritis or a multitude of other factors. For those cases, attaching one or more foam cutouts 10 to either the backside of user's hand 22 or to user's hand members 16 allows the user to successfully type on electronic device 20.

Similarly, it is quite common for physically challenged individuals to have difficulty turning the hands in order to type or perform similar actions. For example, a person with quadriplegia, who is experiencing paralysis in some or all of his or her limbs, has difficulty performing certain tasks. For these people, attaching one or more foam cutouts 10 to either the backside of user's hand 22 or to user's hand members 16 allows the user to type on electronic device 20, which would not be possible if the user had to turn his or her hand over in order to type in the customary fashion.

Although the preceding text describes placing foam cutout 10 on the back of the hand or hand members in the case of physically challenged or older individuals who have lost mobility in the arms and/or hands, the reader should not take this as limiting the possible uses for the present invention. It is the intent for foam cutout 10 to be used in any manner possible or necessary. Foam cutout 10 can just as easily be placed on a user's big toe, heal, palm, elbow, nose, chin, or any other body part that user feels would assist in operating an electronic device.

Another application of the current invention is shown in FIG. 4. By attaching foam cutout 10 to an electrically conductive writing utensil 24, one can use a common pen or pencil as a conductive pen stylus. This allows the user to write on electronic device 20 using a writing utensil. Rather than typing or using the finger, the user can hand-write notes on electronic device 20 with the accuracy of writing utensil 24. Attaching foam cutout 10 to conductive writing utensil 24 also assists those who draw or sketch using electronic device 20. Drawing with a utensil is often easier than drawing with one's finger. The current invention provides a device that can be used both attached to the user's finger and attached to a common writing utensil—this flexibility creates versatility not found in the prior art.

Many electronic devices 20 use a change in capacitance to sense the touch of a user. In fact, nearly all of the devices on the market use a capacitive touch screen for reasons discussed in the preceding text. Since a user's body acts as a capacitor, when user's hand member 16 contacts touch screen 18, a change in capacitance is sensed by electronic device 20. Because foam cutout 10 is preferably electrically conductive, a capacitor is dynamically formed when the foam cutout 10 touches the screen 18 while in contact with the user. Unfortunately, the charge of the body does not always conduct through the plastic or foam typically used to construct the cover of a prosthetic limb. Thus, another method must be used in order to navigate a touch screen on an electronic device with a capacitance touch screen while using some prosthetic limbs. The reader will note that some prosthetic limbs, especially those that contain electronics for muscular control by the user, are capable of using a capacitive touch screen with foam cutout 10 attached to the limb.

Thus far foam cutout 10 has been attached to electrically conductive objects which are in contact with the user's skin. The reader will note that the length of these objects is unimportant in terms of transferring the electrical conductivity from the user. Those skilled in the art will be familiar with the ineffectiveness of a metallic object used to operate a conductive touch screen on an electronic device (discussed in the preceding text in more detail). Currently, more and more devices are operated using a capacitive touch screen. Attaching foam cutout 10 to a longer object increases the number of possible applications of current invention. There are a wide range of environments that humans cannot enter. For example, doctors cannot enter highly contagious quarantined rooms or may require a completely sterile environment to which they cannot enter, technicians cannot come within a certain distance of a highly radioactive area, and human skin cannot be exposed in space. All of the users in these examples can benefit from the use of a long rod with foam cutout 10 attached to the end. Typically, the screen used to operate a device is proximate that device. In the case of the patient in a quarantined room—the screen showing his or her vitals is next to the bed. By attaching foam cutout 10 to a long rod, the user (whether he or she is a doctor, scientist, or astronaut) can remain at a safe distance from the problem space while still operating a device with a touch screen.

While the application of the current invention described in the preceding paragraph relates primarily to environments which the user cannot (or should not) enter, this particular embodiment should not be limited to that application. It is possible for a physically challenged individual (depending on his or her condition) to benefit from having an extended limb or rod to use. Attaching foam cutout 10 to the end of a long rod allows the user to reach a much further distance to navigate an electronic device. For example, a user constrained to a wheelchair could reach a tablet device placed on the floor from his or her chair.

FIG. 5 shows prior art prosthetic arm 26. The particular arm shown in the figure is one of many common prosthetic arm types known in the art. The prosthetic arm 26 shown is a more functional version of a prosthetic arm—other types of prosthesis are discussed further in the subsequent text. Prosthetic arm 26 includes grasping mechanism 28, pylon 30, lever 32, and cable 34. Grasping mechanism 28 is used to grasp and hold objects. Pylon 30 is the structural component of prosthetic arm 26. The prosthetic arm shown is intended for use for an amputee who has a limb amputated below the elbow. The amputated limb is inserted through the hollow upper section 36 such that the user's elbow is aligned with joint 38. In the event that the user's amputation occurred above the elbow, simple joint 38 would be replaced with a ball joint intended to imitate the motion of a human elbow.

Grasping mechanism 28 can be controlled by the user in different ways. Certain systems integrate grasping mechanism 28 with the user's body by attaching electrodes to the user's arm. For a prosthetic arm, a certain muscular contraction in the user's arm will trigger the grasping mechanism 28. In the case of prosthetic arm 26 shown in FIG. 5, a cable and lever system is used to actuate grasping mechanism 28. Lever 32 is mechanically attached to grasping mechanism 28 such that pulling the lever 32 towards the user opens grasping mechanism 28. Grasping mechanism 28 is spring loaded in such a way that it remains forcibly closed when lever 32 is not actuated. This allows the user to pull lever 32 to open grasping mechanism 28 in order to grasp an object. Then, grasping mechanism 28 continues to hold the object without any input from the user until he or she is ready to release the object. In order to pull lever 32, the user can pull cable 34 using his or her back and shoulders.

Oftentimes, the type of prosthesis shown in FIGS. 5-6 transfers the capacitance of the human body to grasping mechanism 28, if grasping mechanism 28 is metallic, in this case, foam cutout 10 is simply affixed to grasper 40, thereby allowing the user to operate a capacitive touch screen (The user cannot generally operate a capacitive touch screen with the metal grasper 40 alone because it is too rigid and does not deform when pressed against the screen. Some deformation is needed to produce a “contact patch” of sufficient size.). However, in some cases, the capacitance of the human body does not transfer to grasping mechanism 28. Although the conductivity of the human body does not transfer to hook-shaped grasper 40 for those cases, FIG. 6 demonstrates a method of transferring the charge of the human body to grasper 40. Wire 42 is preferably attached to grasping mechanism 28, in a preferred embodiment, grasping mechanism 28 is fabricated almost entirely of metal such that connection point 44 on grasping mechanism 28 is capable of electrical conduction throughout grasping mechanism 28. Thus, by supplying a charge at the base of grasping mechanism 28 (at connection point 44), grasper 40 will be electrically charged. In the demonstrated case, this charge is supplied by the capacitance of the user's body. However, the charge could be generated using another means. For example a simple electrical capacitor can be used to generate the charge needed to use the touch screen. The reader should note that if grasping mechanism 28 is not constructed entirely of electrically conductive metal, connection point can be moved to grasper 40. In addition, if grasper 40 is constructed of a non-conductive material, then foam cutout 10 can be applied to an electrode and connection point 44 can be moved to the position of foam cutout 10. Those familiar with the art will realize that it is preferable to have connection point 44 at the base of grasping mechanism 28 rather than on grasper 40 in order to avoid the moving component of grasper 40.

The reader should note that while the method of transferring the charge created by the human body to grasping mechanism 28 is a wire, there are various techniques to do this. Any material used to conduct electricity can be used, including conductive tape, electrodes, a rod or tubing, or any other material that promotes the capacitance of the body or another object to be transferred to grasper 40.

Those familiar with the art will realize that whether the user has a wired prosthetic arm that is activated by pulling with the opposite shoulder or one that is actuated by muscle contraction that both configurations include a cable or wires that travel along the length of the arm. Thus, the addition of one additional wire is not much (if any) of an inconvenience. This is also relevant to prostheses attached to the limb above the elbow even though there is a bit more complexity involved.

FIG. 7 shows an isolated view of sleeve 46 and user's arm 50. Sleeve 46 acts as the interface between pylon 30 and the user's arm 50. Sleeve 46 can be composed of fabric, gel, silicone, or other soft plastic materials. While it can take many forms, sleeve 46 is most often constructed from a gel or fabric. This is ideal for the present invention as there are conductive gels and fabrics prevalent in the art. Therefore, a preferred embodiment of the present invention is to attach wire 42 to conductive material 48, which can be a conductive gel or fabric depending on the material of sleeve 46. Since conductive material 48 is in contact with user's arm 50, the capacitance of the user's body is transferred to conductive material 48, thereby extending the capacitance of the user to conductive wire 42 and grasping mechanism 28. Thus, allowing the user to use foam cutout 10 on the touch screen of electronic device 20.

Oftentimes sleeve 46 extends past where pylon 30 (not shown in this figure) ends. Conductive gel and fabric are relatively common materials in the art as discussed in the previous text. Preferably, conductive material 48 is integrated into sleeve 46. However, for users who already own sleeve 46, a slit can be cut into sleeve 46 so that wire 42 can be attached to user's arm 50. An alternative to cutting a hole into sleeve 46 is to extend wire 42 past sleeve 46 in order to attach it to user's arm 50. The reader will note that there are many possibilities for the method of attachment of wire 42 to user's arm 50, but the scope of the invention should not be limited to any one method. Instead, the scope of the invention should encompass any method of attachment that allows the user to used foam cutout 10 on touch screen 118.

Another type of prosthetic arm is shown in FIG. 8. The prosthetic arm 26 in FIG. 8 is intended more for cosmetics than functionality. It is typical for an amputee to elect to (1) have multiple prostheses depending on the occasion or (2) simply elect to have a prosthetic limb that is strictly cosmetic. In either case, an amputee has the option of some functionality as well as the cosmetic appeal. Adding the inventive system to a prosthetic limb (or fabricating it with such) allows a user to operate touch screen 18 with his or her prosthetic arm 26, while the other arm is free to perform other tasks. This is especially true for a user with a single amputated arm. By allowing the user to navigate electronic devices 20 with prosthetic arm 26, he or she can utilize the biological arm to perform more precise tasks. Thus, an arm that has been deemed strictly cosmetic can now have functionality.

In a preferred embodiment of the present invention, a significant advantage is created by using cosmetic prosthetic arm 26—the conductive wiring can be integrated into the actual prosthesis. Preferably, it is integrated such that the user is not required to do anything except affix and remove his or her prosthesis as he or she would normally. Wiring preferably runs from the socket to the fingertips with electrodes on one or more fingers. The sleeve is fitted with conductive material which conducts the charge from the user's body (as discussed in the preceding text). Preferably, foam cutout 10 is attached to the electrode on the fingers. In an alternate embodiment of the invention, prosthetic arm 26 includes a simple electrical capacitor in order to create the charge needed for the user to navigate electronic device 20. This embodiment does not require wiring to run to the user, only the wiring used for the electrical capacitor, which is preferably integrated into the hand or arm of prosthetic arm 26. In another alternate embodiment, foam cutout 10 is permanently affixed to the electrode located on prosthetic limb 26.

In some cases, the capacitance of the user's body has been shown to transfer to a conductive material even when the user's body is not in direct contact with the material. An example of this involves a user holding a non-conductive rod with conductive material fastened to that rod. However, the user is not touching the conductive material. The reader can imagine a non-conductive rod wrapped in conductive material everywhere except a section large enough to be held by a user's hand. Then, by grasping the non-conductive section the user can operate a capacitive touch screen with a foam cutout attached to the conductive wrapping, in the case of the current invention, this is used with a prosthetic arm that has metallic components within the limb that would allow the capacitance to “jump” to a conductive material on the outer surface of the prosthesis. For example, if the prosthesis shown in FIG. 8 is a robotic prosthetic arm instead of a plastic, immobile arm, cutout 10 can work without any conductive material connected to the body. The capacitance within in the arm may be great enough to charge the cutout so that it can be used on a capacitive touch screen.

FIG. 9 shows a preferred method of creating foam cutout 10. In a preferred embodiment of the current invention, foam square 52 comes with pre-cut foam cutouts 10. Screen contact end 12 is shown. Preferably, the underside (not shown) contains adhesive covered with a thin sheet of paper. Thus, the foam remains adhesive until the user is ready to use a particular foam cutout 10, allowing the user to remove individual foam cutouts 10 as needed.

The primary advantage of the preferred embodiment shown in FIG. 9 is that the user can push out individual foam cutouts 10 from foam square 52. Preferably, the adhesive substance and the paper that protects that adhesive are applied prior to cutting the foam. Because the foam is die cut with the adhesive backing and paper attached, the user can remove individual foam cutouts with or without the paper covering the adhesive attached. This allows the user to remove individual cutouts before the user is ready to use the cutout if he or she desires. Thus, the user can carry a single foam cutout 10, rather than carry foam square 52. Alternatively, the user can peel back the round cut paper from a single cutout in order to be used immediately. Once the user has pulled the paper away, he or she can apply force to foam cutout 10 from screen contact end 12 while pulling with another hand member 16 attached to adhesive end 14. Once removed, foam cutout 10 is attached to user's hand member 16 and ready for use.

Foam cutout 10 can also be attached to conductive gloves. By pressing the adhesive end of foam cutout 10 onto the conductive portion of a glove, the electric conductivity of the user is transferred through the glove to foam cutout 10. Thus, the user can navigate his or her electronic device more precisely. In addition to more precise navigation, preferably the physical contact between the foam cutout and the touch screen of the electronic device is superior to that of the contact between a conductive glove and a touch screen. This allows for more effective navigation of the user's electronic device.

The preceding description contains significant detail regarding the novel aspects of the present invention. It should not be construed, however, as limiting the scope of the invention, but rather as providing illustrations of the preferred embodiments of the invention. Thus, the scope of the invention should be determined according to the following claims rather than the examples given.

Having described my invention, I claim:

1. A method for a user having skin to accurately and effectively operate a capacitive touch screen located on an electronic computing device, comprising:
a. providing a foam cutout, including,
i. a top surface,
ii. a bottom surface,
iii. an adhesive material applied to said bottom surface of said foam cutout,
iv. wherein said foam cutout is fabricated using a material capable of compression and deformation;
b. applying said bottom surface of said foam cutout to an electrically conductive object such that said adhesive material temporarily attaches said foam cutout to said electrically conductive object;
c. creating contact between said electrically conductive object and a capacitive object; and
d. pressing said top surface of said foam cutout against said capacitive touch screen in order to operate said electronic device by creating a change in capacitance on said capacitive touch screen.

2. The method for a user having skin to accurately and effectively operate a capacitive touch screen as recited in claim 1, wherein said foam cutout is capable of deformation in order to increase an area of contact with said capacitive touch screen.

3. The method for a user having skin to accurately and effectively operate a capacitive touch screen as recited in claim 1, wherein said foam cutout is cylindrical.

4. The method for a user having skin to accurately and effectively operate a capacitive touch screen as recited in claim 1, wherein said electrically conductive object is said skin of said user and said capacitive object is said skin of said user.

5. The method for a user having skin to accurately and effectively operate a capacitive touch screen as recited in claim 1, herein said capacitive object is said skin of said user and said electrically conductive object is a writing utensil.

6. The method for a user having skin to accurately and effectively operate a capacitive touch screen as recited in claim 1, wherein said capacitive object is said skin of said user and said electrically conductive object is a prosthetic limb.

7. The method for a user having skin to accurately and effectively operate a capacitive touch screen as recited in claim 1, wherein said capacitive object is an external electric capacitor and said electrically conductive object is a prosthetic limb.

8. The method for a user having skin to accurately and effectively operate a capacitive touch screen as recited in claim 1, further comprising the step of providing a foam square having a plurality of foam cutouts.

9. The method for a user having skin to accurately and effectively operate a capacitive touch screen as recited in claim 8, wherein said foam cutout is capable of being removed from said electrically conductive object and replaced with a second foam cutout from said plurality of foam cutouts within said foam square.

10. A method for a user having skin to accurately and effectively operate a capacitive touch screen located on an electronic computing device, comprising:
a. providing a foam cutout, including,
i. a top surface,
ii. a bottom surface,
iii. an adhesive material applied to said bottom surface of said foam cutout,
iv. wherein said foam cutout is fabricated using a material capable of compression and deformation;
b. applying said bottom surface of said foam cutout to an electrically conductive object such that said adhesive material temporarily attaches said foam cutout to said electrically conductive object;
c. creating contact between said electrically conductive object and said skin of said user; and
d. pressing said top surface of said foam cutout against said capacitive touch screen in order to operate said electronic device by creating a change in capacitance on said capacitive touch screen.

11. The method for a user having skin to accurately and effectively operate a capacitive touch screen as recited in claim 10, wherein said electrically conductive object is a prosthetic limb having a grasping mechanism.

12. The method for a user having skin to accurately and effectively operate a capacitive touch screen as recited in claim 11, further comprising the step of providing an electrically conductive wire to create contact between said grasping mechanism of said prosthetic limb and said skin of said user.

13. The method for a user having skin to accurately and effectively operate a capacitive touch screen as recited in claim 10, wherein said electrically conductive object is a prosthetic limb.

14. The method for a user having skin to accurately and effectively operate a capacitive touch screen as recited in claim 10, wherein said electrically conductive object is a writing utensil.

15. The method for a user having skin to accurately and effectively operate a capacitive touch screen as recited in claim 10, further comprising the step of providing a foam square having a plurality of foam cutouts.

16. The method for a user having skin to accurately and effectively operate a capacitive touch screen as recited in claim 11, wherein said foam cutout is capable of being removed from said electrically conductive object and replaced with a second foam cutout from said plurality of foam cutouts within said foam square.

17. A method for a user having skin to accurately and effectively operate a capacitive touch screen located on an electronic computing device, comprising:
a. providing a foam square having a plurality of foam cutouts, wherein each of said plurality of foam cutouts include,
i. a top surface,
ii. a bottom surface,
iii. an adhesive material applied to said bottom surface of said foam cutout,
iv. wherein each of said plurality of foam cutouts is fabricated using a material capable of compression and deformation;
b. applying said bottom surface of at least one of said foam cutout to an electrically conductive object such that said adhesive material temporarily attaches said foam cutout to said electrically conductive object; and
c. pressing said top surface of said foam cutout against said capacitive touch screen in order to operate said electronic device by creating a change in capacitance on said capacitive touch screen.

18. The method for a user having skin to accurately and effectively operate a capacitive touch screen as recited in claim 17, wherein said foam cutout is capable of being removed from said electrically conductive object and replaced with a second foam cutout from said plurality of foam cutouts within said foam square.

19. The method for a user having skin to accurately and effectively operate a capacitive touch screen as recited in claim 17, wherein said electrically conductive object is a grasping mechanism of a prosthetic limb.

20. The method for a user having skin to accurately and effectively operate a capacitive touch screen as recited in claim 19, further comprising the step of providing a wire attached at a first end to said grasping mechanism upon which said foam cutout is affixed, and wherein said wire remains in contact with said skin of said user at a second end.
